(19) United States
(12) Patent Application Publication
(10) Pub. No.: US 2026/0127874 A1
(43) Pub. Date: May 7, 2026

(54) PROCESSING CONTROL SYSTEM, PROCESSING CONTROL DEVICE, AND PROCESSING CONTROL METHOD

(71) Applicant: NEC Corporation, Minato-ku, Tokyo (JP)

(72) Inventors: Masaharu MORIMOTO, Tokyo (JP); Koichi NIHEI, Tokyo (JP); Hayato ITSUMI, Tokyo (JP); Florian BEYE, Tokyo (JP); Takanori IWAI, Tokyo (JP)

(73) Assignee: NEC Corporation, Minato-ku, Tokyo (JP)

(21) Appl. No.: 19/118,827

(22) PCT Filed: Oct. 14, 2022
(86) PCT No.: PCT/JP2022/038459

§ 371 Date: Apr. 7, 2025

(51) Int. Cl. G06V 10/94; G06V 20/40

(52) U.S. Cl. CPC G06V 10/955; G06V 10/95; G06V 20/40

(57) ABSTRACT

In order to make it possible to cope with fluctuations of a communication bandwidth, the processing control system (100) includes a switching control means (110) for carrying out control of which processing section analyzes analysis target data, a first processing section or a second processing section and a buffer control means (111) for causing one of the first processing section and the second processing section that is not analyzing the analysis target data to buffer the analysis target data.

### TECHNICAL FIELD

The present invention relates to a processing control system, a processing control apparatus, and a processing control method.

### BACKGROUND ART

Techniques of processing image data acquired via image capture equipment, such as a camera, and analyzing, for example, the subject, such as a person or a physical object, and the motion of the subject have been used. Because of the heavy load, such processing is carried out by distributed processing in many cases. For example, according to Patent Literature 1, super-resolution processing is carried out by distributed processing, by dividing the sequence of image frames to distribute the image frames among a plurality of processing apparatuses and concatenating the image frames after the super-resolution processing. According to Patent Literature 2, prevention of a delay in transferring metadata is sought by calculating the priority of the metadata and allocating, according to the priority, a radio bandwidth to a lower-level server which transfers the metadata.

### CITATION LIST

### Patent Literature

### Patent Literature 1

Japanese Patent Application Publication Tokukai No. 2014-174834

### Patent Literature 2

Japanese Patent Application Publication Tokukai No. 2021-145263

### SUMMARY OF INVENTION

### Technical Problem

However, in some cases, a change in situation affects the distributed processing. For example, the communication bandwidth can fluctuate, and with the techniques disclosed in Patent Literatures 1 and 2, it is impossible to cope with the fluctuations of the communication bandwidth, and a significant delay in processing and an omission in processing could be caused, accordingly.

To address this, the inventors of the present invention have considered, on the basis of their own findings, switching a processing section which carries out processing, among a plurality of processing sections which are involved in distributed processing, to suit the situation. However, even with the switching of a processing section which carries out processing, an omission in processing could be caused and the accuracy could decrease.

An example aspect of the present invention has been made in view of the above problem, and an example object thereof is to provide a processing control system, a processing control apparatus, and a processing control method which make it possible to accurately carry out distributed processing.

### Solution to Problem

A processing control system in accordance with an example aspect of the present invention is a processing control system for controlling a first processing section and a second processing section which is capable of communicating with the first processing section, the first processing section is configured to analyze at least part of analysis target data and transmit at least part of the analysis target data to the second processing section, the second processing section is configured to analyze the at least part of the analysis target data that is transmitted from the first processing section, and the processing control system includes: a switching control means for carrying out control of which processing section analyzes the analysis target data, the first processing section or the second processing section; and a buffer control means for causing one of the first processing section and the second processing section that is not analyzing the analysis target data to buffer the analysis target data.

A processing control apparatus in accordance with an example aspect of the present invention is a processing control apparatus for controlling a first processing section and a second processing section which is capable of communicating with the first processing section, the first processing section is configured to analyze at least part of analysis target data and transmit at least part of the analysis target data to the second processing section, the second processing section is configured to analyze the at least part of the analysis target data that is transmitted from the first processing section, and the processing control apparatus includes: a switching control section for carrying out control of which processing section analyzes the analysis target data, the first processing section or the second processing section; and a buffer control section for causing one of the first processing section and the second processing section that is not analyzing the analysis target data to buffer the analysis target data.

A processing control method in accordance with an example aspect of the present invention is a processing control method for controlling a first processing section and a second processing section which is capable of communicating with the first processing section, a switching control process of carrying out control of which processing section analyzes analysis target data, the first processing section or the second processing section, and a buffer control process of causing one of the first processing section and the second processing section that is not analyzing the analysis target data to buffer the analysis target data are carried out, and the first processing section is configured to analyze at least part of the analysis target data and transmit at least part of the analysis target data to the second processing section, and the second processing section is configured to analyze the at least part of the analysis target data that is transmitted from the first processing section.

### Advantageous Effects of Invention

With an example aspect of the present invention, it is possible to accurately analyze analysis target data via a plurality of processing sections.

### BRIEF DESCRIPTION OF DRAWINGS

FIG. 1 is a block diagram illustrating an example configuration of a processing control system in accordance with a first example embodiment.

FIG. 2 is a block diagram of an example configuration of a processing system which is controlled by the processing control system.

FIG. 3 is a flowchart illustrating an example flow of a processing control method S100 in accordance with the first example embodiment.

FIG. 4 is a block diagram illustrating an example configuration of a processing control apparatus 200 in accordance with the first example embodiment.

FIG. 5 is a block diagram illustrating an example configuration of a processing control system in accordance with a second example embodiment.

FIG. 6 is a schematic view of an example of analysis target data which is outputted from image capture equipment.

FIG. 7 is a schematic view of an example of analysis target data which is outputted from image capture equipment.

FIG. 8 is a graph representing the result of a communication bandwidth estimation carried out via a bandwidth estimating means.

FIG. 9 is a block diagram illustrating an example configuration of a processing control system in accordance with a third example embodiment.

FIG. 10 is a block diagram illustrating an example configuration of a processing control system in accordance with a fourth example embodiment.

FIG. 11 is a block diagram illustrating an example configuration of a processing control system in accordance with a fifth example embodiment.

FIG. 12 is a block diagram illustrating an example configuration of a processing control system in accordance with a sixth example embodiment.

FIG. 13 is a block diagram illustrating an example configuration of a processing control system in accordance with a seventh example embodiment.

FIG. 14 is a block diagram illustrating an example configuration of a processing control system in accordance with an eighth example embodiment.

FIG. 15 is a block diagram illustrating an example configuration of a processing control system in accordance with a tenth example embodiment.

FIG. 16 is a block diagram illustrating an example configuration of a processing control system in accordance with an eleventh example embodiment.

FIG. 17 is a block diagram illustrating an example configuration of a processing control system in accordance with a twelfth example embodiment.

FIG. 18 is a block diagram illustrating an example configuration of a computer.

### EXAMPLE EMBODIMENTS

### First Example Embodiment

The following description will discuss a first example embodiment of the present invention in detail with reference to the drawings. The present example embodiment is basic to example embodiments which will be described later.

### Configuration of Processing Control System

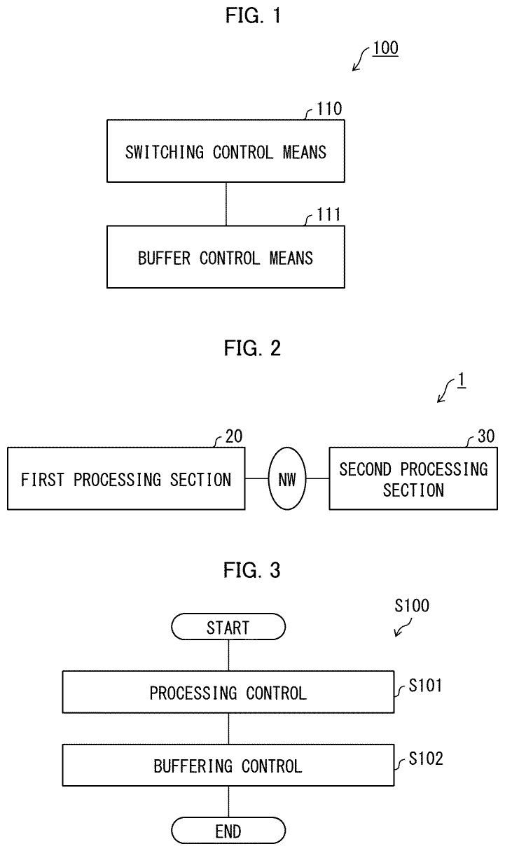

The configuration of a processing control system in accordance with the present example embodiment is described here with reference to FIG. 1. FIG. 1 is a block diagram illustrating an example configuration of a processing control system 100 in accordance with a first example embodiment. The processing control system 100 includes a switching control means 110 and a buffer control means 111, and controls a processing system.

FIG. 2 is a block diagram illustrating an example configuration of a processing system controlled by the processing control system. A processing system 1 includes a first processing section 20 and a second processing section 30.

The first processing section 20 is connected to, for example, a camera or a sensor or the like, such as Light Detection and Ranging (LiDAR), and acquires analysis target data from the camera or the sensor or the like. As an example, the analysis target data may be video data captured by the camera. The video data only needs to be such that an analysis target is within the angle of view of the video. Examples of the analysis target include a worker (person) who is working in a construction site, working equipment (physical object), and the behavior (operation) of the worker or the working equipment. Further, the analysis target data may be sensing data of a sensor which has detected the analysis target.

The first processing section 20 and the second processing section 30 can each be formed by one or more computers. The first processing section 20 and the second processing section 30 are capable of communicating with each other over a network NW, and shares the analysis of the analysis target data therebetween. The network NW may be a wireless or wired network, and in a case of a wireless network, the network NW may be a radio communications system, such as Wi-Fi, LTE, 4G, or 5G.

According to an example aspect, the first processing section 20 and the second processing section 30 may be an edge processing section and a cloud processing, respectively. As used herein, “edge” refers to a location where data collection is carried out. The first processing section 20, which is the edge processing section, is an information processing apparatus (computer) or an information processing apparatus group which is installed in a place (e.g., a construction site, a factory, or the like) where the analysis target is present or in the vicinity of the place, and acquires analysis target data from a camera or a sensor or the like that is installed in the place, where the analysis target is present. The first processing section 20 may be integrated with the camera or the sensor or the like. Further, as used herein, “cloud” refers to a location where processing, storage, etc. of data are carried out. The second processing section 30, which is a cloud processing section, may be an information processing apparatus (computer) or an information processing apparatus group which is installed in a place where it is possible to provide a large computing resource, such as a data center or a server farm. Note that the second processing section 30 only needs to be in a place that is connected to the first processing section 20 over a network, and may be, for example, a computing resource (e.g., multi-access edge computing (MEC)) that is connected to a base station of 5G or the like, or a server (on-premises server) that is installed in an on-site office or the like.

Sharing of the analysis of the analysis target data between the first processing section 20 and the second processing section 30 can be carried out in various manners. Examples of the sharing manner include: analyzing the analysis target data in the first processing section 20 that acquires the analysis target data; preprocessing the analysis target data in the first processing section 20 that acquires the analysis target data and analyzing the preprocessed analysis target data in the second processing section 30; and subjecting the analysis target data to processing such as compression in the first processing section 20 and analyzing the analysis target data in the second processing section 30. For example, a scheme for sharing the analysis of the analysis target data may be selected, according to the computational ability of the first processing section 20, from among: a first sharing scheme in which the first processing section 20 generates the result of an analysis of analysis target data; a second sharing scheme in which the first processing section 20 calculates the features of the analysis target data, the features are transmitted from the first processing section 20 to the second processing section 30, and the second processing section 30 generates a result of analysis based on the features; and a third sharing scheme in which the analysis target data is transmitted from the first processing section 20 to the second processing section 30 and the second processing section 30 generates the result of an analysis of the analysis target data. The criterion used for the sharing scheme selection may be computational cost, the importance of analysis target data, riskiness indicated by analysis target data, and the compression efficiency, the communication quality, etc. of each piece of analysis target data, in addition to computational ability. By distinguishing among these sharing schemes in their usage, it is possible to efficiently carry out analytical processing according to situations.

According to an example aspect, the first processing section 20 analyzes at least part of the analysis target data acquired and transmits at least part of the analysis target data to the second processing section 30. In this transmission, the analysis target data to be transmitted to the second processing section 30 is at least part of the analysis target data (the remaining part of the analysis target data) for which not all the processing for the analysis is completed in the first processing section 20. The first processing section 20 transmits the at least part of the analysis target data (e.g., at least part of the remaining part of the analysis target data) to the second processing section 30 over the network NW. The second processing section 30 receives and analyzes the analysis target data (e.g., the at least part of the remaining part of the analysis target data) transmitted from the first processing section 20.

Note that the analysis target data to be transmitted from the first processing section 20 to the second processing section 30 may be preprocessed in the first processing section 20. For example, the first processing section 20 may calculate features of the analysis target data and transmit the features to the second processing section 30, and the second processing section 30 may analyze the features. Herein, the analysis target data shall include data (e.g. features) obtained by preprocessing analysis target data. Also herein, analyzing analysis target data refers to generating a result of an analysis of analysis target data, and only carrying out the preprocessing of the analysis target data does not fall under the analyzing of the analysis target data.

The analysis of analysis target data is, for example, detection, identification, tracking, and time-series analysis of an analysis target (physical object, person) on video. AI may be used for this processing of analysis target data. Either one or both of the first processing section 20 and the second processing section 30 may use AI.

The processing control system 100 (switching control means 110, buffer control means 111) controls the processing system 1. In particular, the processing control system 100 controls the first processing section 20 and the second processing section 30.

The switching control means 110 carries out control of which processing section analyzes analysis target data, the first processing section 20 or the second processing section 30. The switching control means 110 can switch a processing sections which analyzes analysis target data on the basis of various factors. For example, the switching control means 110 can carry out the switching on the basis of, for example, the communication bandwidth of communication between the first processing section 20 and the second processing section 30.

The buffer control means 111 causes one of the first processing section 20 and the second processing section 30 that is not analyzing analysis target data to buffer the analysis target data. In this respect, in a case where one of the first processing section 20 and the second processing section 30 switches from a state of not analyzing analysis target data to a state of analyzing the analysis target data, if it is impossible for the one to use, for the analysis, the analysis target data processed in the other before the switching, the accuracy of the analysis could decrease. However, according to the present example embodiment, even in a case of the switching from the state of not analyzing the analysis target data to the state of analyzing the analysis target data, it is possible for the first processing section 20 and the second processing section 30 to use the analysis target data buffered. This makes it possible to accurately analyze the analysis target data.

### Flow of Processing Control Method

The flow of a processing control method S100 in accordance with the present example embodiment is described here with reference to FIG. 3. FIG. 3 is a flowchart illustrating the flow of the processing control method S100 in accordance with the first example embodiment.

In step S101, the switching control means 110 carries out control of which processing section analyzes analysis target data, the first processing section 20 or the second processing section 30.

In step S102, the buffer control means 111 causes one of the first processing section 20 and the second processing section 30 that is not analyzing the analysis target data to buffer the analysis target data.

As above, in the processing control method S100 in accordance with the present example embodiment, even in a case of switching from a state of not analyzing analysis target data to a state of analyzing the analysis target data, it is possible for the first processing section 20 and the second processing section 30 to use the analysis target data buffered. This makes it possible to accurately analyze the analysis target data.

### Configuration of Processing Control Apparatus

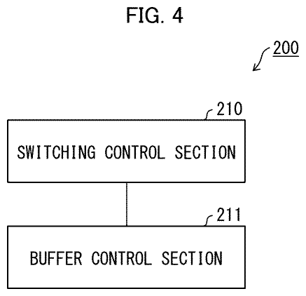

The configuration of a processing control apparatus 200 in accordance with the present example embodiment is described here with reference to FIG. 4. FIG. 4 is a block diagram illustrating the configuration of the processing control apparatus 200 in accordance with the first example embodiment. The processing control apparatus 200 includes a switching control section 210 and a buffer control section 211, and controls the processing system 1 (the first processing section 20 that acquires analysis target data and the second processing section 30 that is capable of communicating with the first processing section 20).

The switching control section 210 has a function equivalent to that of the switching control means 110, and carries out control of which processing section analyzes analysis target data, the first processing section 20 or the second processing section 30. The buffer control section 211 has a function equivalent to that of the buffer control means 111, and causes one of the first processing section 20 and the second processing section 30 that is not analyzing the analysis target data to buffer the analysis target data.

The switching control section 210 and the buffer control section 211 may each be computer equipment in which processing is carried out upon a processor executing a program stored in a memory. For example, the switching control section 210 and the buffer control section 211 may each be a single piece of computer equipment, or may be a computer equipment group which operates through coordination among a plurality of pieces of computer equipment or a server equipment group which operates through coordination among a plurality of pieces of server equipment. Further, at least part of the switching control section 210 and the buffer control section 211 may be provided in the second processing section 30. With the processing control apparatus 200, it is possible to obtain an example advantage equivalent to that provided by the processing control system 100.

### Second Example Embodiment

The following description will discuss a second example embodiment of the present invention in detail with reference to the drawings. Note that a component having the same function as a component described in the first example embodiment is assigned the same reference sign, and the description thereof is omitted where appropriate.

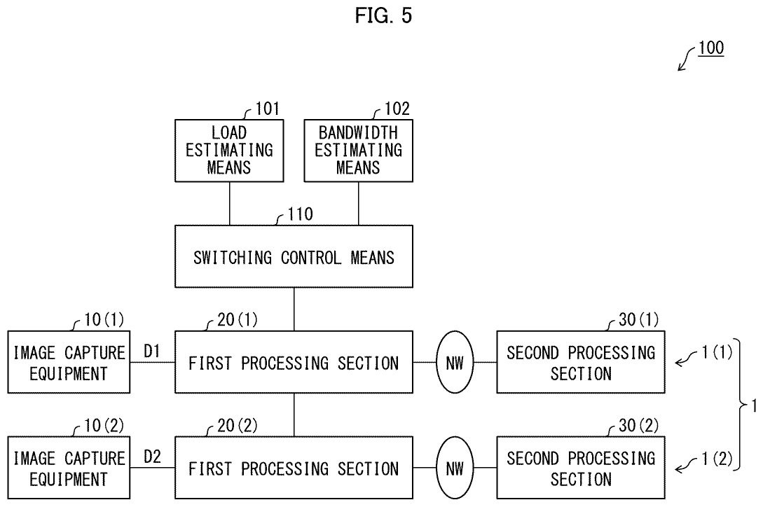

FIG. 5 is a block diagram illustrating an example configuration of a processing control system 100 in accordance with the second example embodiment. The processing control system 100 includes a load estimating means 101, a bandwidth estimating means 102, and a switching control means 110, and controls processing systems 1(1) and 1(2).

The processing system 1 in accordance with the present example embodiment includes the processing system 1(1) (image capture equipment 10(1), first processing section 20(1), second processing section 30(1)) and the processing system 1(2) (image capture equipment 10(2), first processing section 20 (2)), second processing section 30(2)). The processing system 1(1) and the processing system 1(2) are controlled by the processing control system 100 independently of each other. Although the two processing systems 1(1) and (2) are illustrated here, the number of the processing systems 1(i) may be not less than three (i: positive integer).

According to the present example embodiment, the sharing of processing of analysis target data between the first processing section 20 and the second processing section 30 is carried out, for example, as follows. In the processing system 1(1), the first processing section 20(1) is controlled by the processing control system 100, to process at least part of analysis target data D1 which is acquired from the image capture equipment 10(1) and transmit at least part of the analysis target data D1 to the second processing section 30(1). In this transmission, the analysis target data to be transmitted to the second processing section 30(1) is at least part of the analysis target data (the remaining part of the analysis target data) for which not all the processing for the analysis is completed in the first processing section 20(1). For example, the first processing section 20(1) transmits, to the second processing section 30(1), at least part of the remaining part, which is unprocessed in the first processing section 20(1), of the analysis target data D1. The second processing section 30(1) receives and processes the analysis target data D1 (i.e., at least part of the analysis target data; e.g., at least part of the remaining part, which is unprocessed in the first processing section 20(1), of the analysis target data) transmitted from the first processing section 20(1). Further, the first processing section 20(1) may transmit, to the second processing section 30(1), at least part of intermediate data (e.g., features) obtained as a result of processing the analysis target data in the first processing section 20, and the second processing section 30(1) may perform further processing on the at least part of the intermediate data received. Similar processing is carried out in the processing system 1(2).

That is, processing of the analysis target data D1 outputted from the image capture equipment 10(1) is shared between the first processing section 20(1) and the second processing section 30(1). Similarly, processing of analysis target data D2 outputted from the image capture equipment 10(2) is shared between the first processing section 20 (2) and the second processing section 30(2).

The load estimating means 101 estimates a processing load of analysis target data in the first processing section 20. For example, the processing load is the amount of usage of a computing resource for use in processing (including processing for analysis and preprocessing) of analysis target data (the amount of usage per unit time of a CPU and/or a GPU that is required for processing the analysis target data) in the first processing section 20. The load estimating means 101 is capable of estimating a future processing load by, for example, monitoring temporal changes in the processing load (e.g., the number of processing target persons, the size of a processing target person, the amount of usage of a computing resource, a processing speed, or a combination thereof) of the analysis target data in the first processing section 20. Further, as another example aspect, the processing load may be estimated on the basis of a processing speed at which the analysis target data is processed (the amount of analysis target data processed per unit time).

The bandwidth estimating means 102 estimates a communication bandwidth of communication between the first processing section 20 and the second processing section 30. For example, the communication bandwidth is a data transfer rate (the amount of transfer of data per unit time) at which transfer between the first processing section 20 and the second processing section 30 is possible. The bandwidth estimating means 102 is capable of estimating a future communication bandwidth by, for example, monitoring temporal changes in the communication bandwidth (e.g. transfer rate) between the first processing section 20 and the second processing section 30.

The switching control means 110 carries out, based on the processing load estimated by the load estimating means 101 and the communication bandwidth estimated by the bandwidth estimating means 102, control of which processing section analyzes analysis target data, the first processing section 20 or the second processing section 30.

For example, in a case where the processing load estimated in the first processing section 20 approaches the limit of the processing speed of the first processing section 20 during processing in the first processing section 20, the switching control means 110 switches the analysis of analysis target data from the first processing section 20 to the second processing section 30. For example, in a case where a required data transfer rate (e.g., the speed of transfer from a camera or the like) approaches the lower limit (a lower bandwidth limit Bmin, which will be described later) of the estimated bandwidth available for transmission during processing in the second processing section 30, the switching control means 110 switches the analysis of analysis target data from the second processing section 30 to the first processing section 20. In a case where a portion (analysis target data portion) of analysis target data is analyzed in the first processing section 20, the first processing section 20 may analyze the analysis target data portion and do not need to transmit the analysis target data portion to the second processing section 30. In a case where analysis target data (analysis target data portion) is analyzed in the second processing section 30, the first processing section 20 does not analyze the analysis target data portion, carries out a suitability process of the analysis target data, and then transmits the analysis target data to the second processing section 30. The second processing section 30 analyzes at least part of the analysis target data transmitted from the first processing section 20.

In this manner, the processing control system 100 carries out, based on the estimated processing load and communication bandwidth, control of which processing section analyzes analysis target data, the first processing section 20 or the second processing section 30. Thus, with the processing control system 100 in accordance with the present example embodiment, it is possible to switch, based on a communication bandwidth, processing between the first processing section 20 and the second processing section 30.

Assume that different bandwidths are allocated for transmitting the analysis target data D1, D2 outputted from the image capture equipment 10(1), 10(2). For example, according to the number of dots of an image of analysis target data and the number per unit time of frames of the analysis target data, the amount per unit time of the analysis target data, i.e., a bandwidth (e.g. transfer rate) required for the transmission of the analysis target data varies. Typically, if a greater bandwidth is allocated for transmitting analysis target data, the analysis target data is considered to be more important. The purpose of this is to allocate a great bandwidth for transmitting important analysis target data, to increase the amount of information obtained from the important analysis target data.

Hereinafter, for the sake of plainness, the image capture equipment 10(1) and the image capture equipment 10(2) can be referred to as image capture equipment 10, without making a distinction therebetween. Similarly, the first processing section 20(1) and the first processing section 20(2) can be referred to as the first processing section 20, and the second processing section 30(1) and the second processing section 30(2) can be referred to as the second processing section 30.

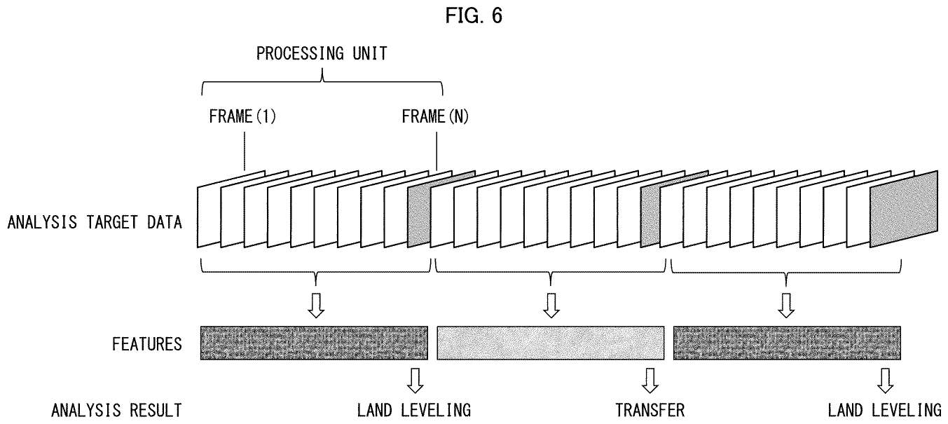

FIG. 6 is a schematic view of an example of analysis target data outputted from the image capture equipment 10. The analysis target data has a plurality of chronologically successive frames. The first processing section 20 and the second processing section 30 process the analysis target data in unit frame sets, each of which is a processing unit and is constituted by a predetermined number N of frames. In this example, the frames in the unit frame set, which is the processing unit, are sequentially assigned numbers of 1 to N (predetermined number). The predetermined number N is the number of frames that constitute the unit frame set.

The first processing section 20 and the second processing section 30 process analysis target data in unit frame sets. As described above, the first processing section 20 and the second processing section 30 share the processing of analysis target data therebetween. Thus, while one of the first processing section 20 and the second processing section 30 is processing a unit frame set of analysis target data, the processing can be switched to the other. In this case, since neither the first processing section 20 nor the second processing section 30 has the entire data of this unit frame set, it is difficult to finish the processing of this unit frame set. For example, in a case where immediately after the first processing section 20 processes the m-th (m<N) frame of a unit frame set, the processing is switched to the second processing section 30, the result of the processing of m frames that have been processed in the first processing section 20 could end up wasted. How to address this will be described later.

The first processing section 20 and the second processing section 30 process analysis target data in unit frame sets, and extract features. The features include, for example, information for detecting and identifying an analysis target (physical object, person) on video. The first processing section 20 and the second processing section 30 carry out tracking and time-series analysis of the analysis target on the basis of the features, and analyze, for example, the work (e.g. land leveling work, transfer work) of a person (worker) to output the result of the analysis. Note that the first processing section 20 and the second processing section 30 may extract features for each frame, carry out an analysis for each unit frame set on the basis of the features, and output the result of the analysis.

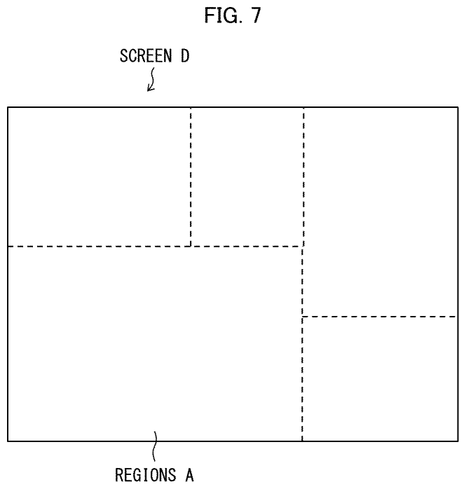

Illustrated in FIG. 7 is an example of video which is represented by analysis target data. In this example, a screen D of the video is divided into a plurality of regions A as processing is carried out in the first processing section 20 and the second processing section 30. In this manner, the first processing section 20 or the second processing section 30 may divide an image represented by the analysis target data into a plurality of regions on the basis of features, and analyze the work of a person (worker) for each of the regions.

This result (work) of analysis can be displayed on a terminal carried by, for example, a supervisor (as an example, a field supervisor) together with the analyzed video, through communication or the like from the first processing section 20 or the second processing section 30. This makes it possible for the supervisor to check on not only the video of a worksite but also the result of an analysis of work, correctly understand the status of the work, and provide people on the site with correct instructions.

The first processing section 20 and the second processing section 30 judge the reliability of a result of analysis. This reliability is acquired by a processing result acquiring means 103, which will be described later. The reliability is an index which indicates the degree of confidence in an estimated result of analysis. In a case where analysis target data is analyzed via AI, it is possible to make the analysis more reliable by additionally evaluating the reliability of a result of analysis. In this case, in addition to the result of analysis, a parameter of the reliability is outputted. Note that for example, if the reliability is high at a certain time, then the first processing section 20 or the second processing section 30 may judge that the same result of analysis is highly likely to stably be outputted at the next time, and if the reliability is low, then the first processing section 20 or the second processing section 30 may judge that a result of analysis which is different from the previous result of analysis is highly likely to be outputted at the next time.

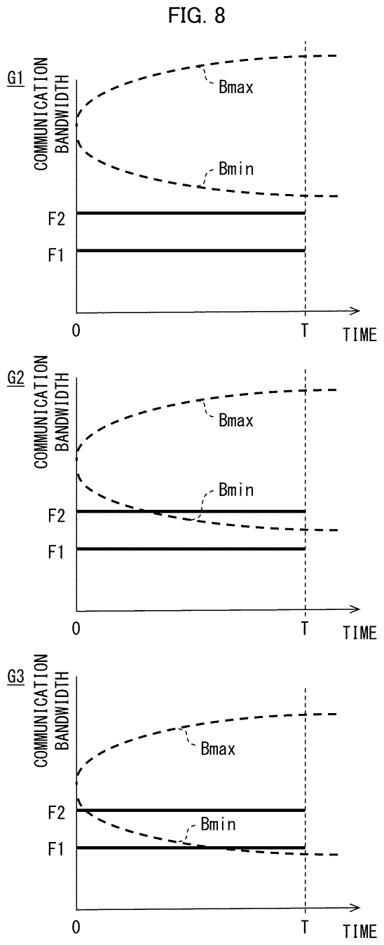

Illustrated in FIG. 8 are graphs G1 to G3 which represent examples of the result of estimation, carried out by the bandwidth estimating means 102, of a communication bandwidth of communication between the first processing section 20 and the second processing section 30. Respective examples of a temporal change in the communication bandwidth from a current point in time are illustrated in graphs G1 to G3. The upper limit and the lower limit of an estimated communication bandwidth are indicated by an upper bandwidth limit Bmax and a lower bandwidth limit Bmin. As time passes, the upper bandwidth limit Bmax increases and the lower bandwidth limit Bmin decreases, and the range of the estimated bandwidth becomes wider, accordingly. This means that as time passes from the current point in time to the future, the certainty of the estimated bandwidth decreases.

The temporal range of the estimation carried out by the bandwidth estimating means 102 only needs to be from the current point in time to a time (unit time) T which corresponds to the unit frame set. This is because since the processing of analysis target data is performed in unit frame sets, switching of the processing of analysis target data, the switching being made after the unit time T, does not affect processing of a currently-processed unit frame set. That is, the value of the lower bandwidth limit Bmin at a point which is into the future by the unit time T can be used for a determination made at the current point in time regarding switching of processing.

The respective estimated communication bandwidths of the graphs G1, G2, and G3 become smaller in this order. That is, the respective lower bandwidth limits Bmin after the unit time T of the graphs G1, G2, and G3 become lower in this order. Estimated data amounts F1 and F2 each mean the amount (transfer rate, i.e. bandwidth) of data which is to be processed in the second processing section 30, and each are, for example, the amount of data which is part of analysis target data that has remained after processing of the analysis target data in the first processing section 20. In the examples, the two estimated data amounts F1 and F2 are fixed for the sake of plainness.

The switching control means 110 carries out, based on the processing load estimated by a load estimating section 201 and the communication bandwidth estimated by the bandwidth estimating means 102, control of which processing section analyzes analysis target data, the first processing section 20 or the second processing section 30. For example, in a case where the processing load estimated in the first processing section 20 approaches the limit of the processing speed of the first processing section 20 during an analysis in the first processing section 20, the switching control means 110 switches the analysis of analysis target data from the first processing section 20 to the second processing section 30. For example, in a case where a required processing speed (e.g. estimated data amount F) for analysis target data approaches an estimated bandwidth (lower bandwidth limit Bmin) during an analysis in the second processing section 30, the switching control means 110 switches the analysis of the analysis target data from the second processing section 30 to the first processing section 20.

For example, since the lower bandwidth limit Bmin projected to be after a time T is greater than the estimated data amounts F (F1, F2) in the graph G1, in either case of the estimated data amount F1 or the estimated data amount F2, the whole amount thereof is not analyzed in the first processing section 20 and can be transmitted from the first processing section 20 to the second processing section 30 to be analyzed in the second processing section 30. In the graph G2, in a case of the estimated data amount F1, the whole amount thereof can be analyzed in the first processing section 20, and in a case of the estimated data amount F2, it is difficult to analyze the whole amount thereof in the first processing section 20. In the graph G3, in either case of the estimated data amount F1 or the estimated data amount F2, it is difficult to analyze the whole amount thereof in the first processing section 20. In such a case, to the extent consistent with the lower bandwidth limit Bmin, the remaining part of analysis target data can be transmitted from the first processing section 20 to the second processing section 30 for analysis.

The switching control means 110 may determine an analysis target data portion of the analysis target data that is to be discarded. In this case, the first processing section 20 neither analyzes nor transmits to the second processing section 30 this analysis target data portion. This results in discarding of the analysis target data portion. Note that the discarding of analysis target data can be interchangeable with not analyzing the analysis target data.

The switching control means 110 may determine, based on a communication bandwidth estimated by the bandwidth estimating means 102, the analysis target data portion of analysis target data that is to be discarded. For example, the switching control means 110 determines that an analysis target data portion (e.g. frame) the data amount of which is the excess over the sum of an estimated processing load and an estimated communication bandwidth should be discarded.

The switching control means 110 may determine, based on the communication bandwidths allocated for transmitting the analysis target data D1 and the analysis target data D2, the analysis target data portion of analysis target data portion that is to be discarded. As described above, different bandwidths are allocated for transmitting the analysis target data D1 and the analysis target data D2 outputted from the image capture equipment 10(1) and the image capture equipment 10(2). For example, the switching control means 110 judges that an analysis target data portion of analysis target data which is allocated a great communication bandwidth is of low importance, and determines that the analysis target data portion should preferentially be discarded in a case of a decrease in an overall usable bandwidth.

With this configuration, it is possible to switch, based on a communication bandwidth, an analysis between the first processing section 20 and the second processing section 30. Further, it is possible to determine, based on an estimated communication bandwidth or an allocated communication bandwidth, an analysis target data portion to be discarded.

Although the second example embodiment is the processing control system 100 in the above description, the second example embodiment may be a processing control apparatus into which the processing control system 100 in accordance with the second example embodiment is incorporated. Further, the operation of the processing control system 100 in accordance with the second example embodiment may be a processing control method in accordance with the second example embodiment.

### Third Example Embodiment

The following description will discuss a third example embodiment of the present invention in detail with reference to the drawings. The same reference sign is assigned to a component that has the same function as the component described in the first example embodiment, and the description thereof is not repeated.

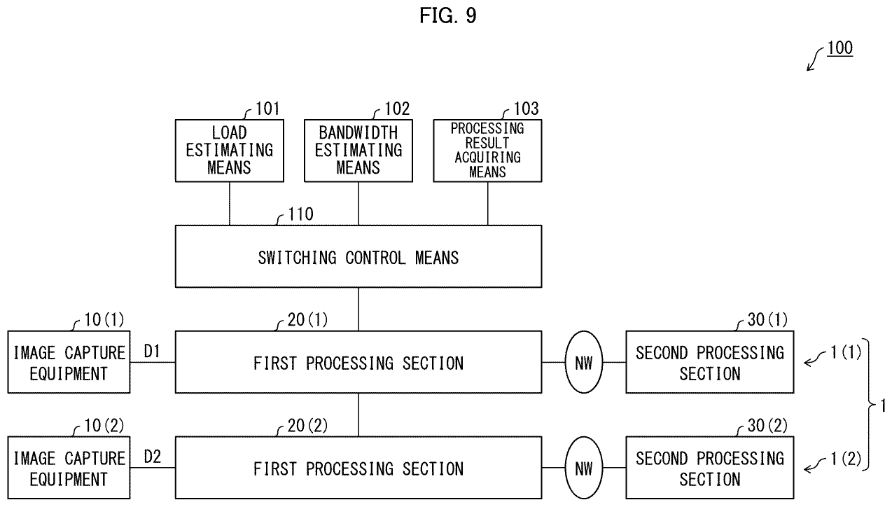

FIG. 9 is a block diagram illustrating an example configuration of a processing control system 100 in accordance with the third example embodiment. The processing control system 100 includes a load estimating means 101, a bandwidth estimating means 102, a processing result acquiring means 103, and a switching control means 110, and controls processing systems 1(1) and 1(2). The processing control system 100 in accordance with the present example embodiment differs from that of the second example embodiment in that the switching control means 110 determines, based on reliability, analysis target data to be discarded.

The processing result acquiring means 103 acquires the reliability of processing of analysis target data, from the first processing section 20 or the second processing section 30, for example. As described above, the first processing section 20 or the second processing section 30 is capable of not only analyzing analysis target data via AI but also judging the reliability of an analysis result. The processing result acquiring means 103 can acquire the reliability of processing of analysis target data together with an analysis result, from the first processing section 20 or the second processing section 30.

Based on the reliability acquired by the processing result acquiring means 103, the switching control means 110 determines an analysis target data portion of the analysis target data that is to be discarded. For example, the processing result acquiring means 103 judges that the analysis target data portion which has relatively high reliability in the previous time is highly likely to provide the same result at the current time, and determines that the processing of the analysis target data portion should be interrupted and discarded. This makes it possible to obtain an analysis result based on the analysis result at the previous time for the analysis target data portion of high reliability and obtain an analysis result at the current time for the analysis target data portion of low reliability.

Although the third example embodiment is the processing control system 100 in the above description, the third example embodiment may be a processing control apparatus into which the processing control system 100 in accordance with the third example embodiment is incorporated. Further, the operation of the processing control system 100 in accordance with the third example embodiment may be a processing control method in accordance with the third example embodiment.

### Fourth Example Embodiment

The following description will discuss a fourth example embodiment of the present invention in detail with reference to the drawings. The same reference sign is assigned to a component that has the same function as the component described in the first example embodiment, and the description thereof is not repeated.

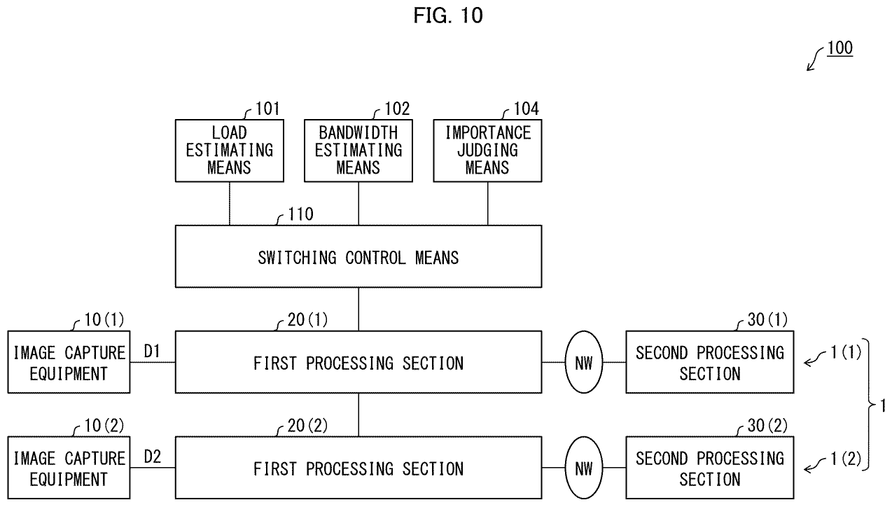

FIG. 10 is a block diagram illustrating an example configuration of a processing control system 100 in accordance with the fourth example embodiment. The processing control system 100 includes a load estimating means 101, a bandwidth estimating means 102, an importance judging means 104, and a switching control means 110, and controls processing systems 1(1) and 1(2). The processing control system 100 in accordance with the present example embodiment differs from that of the second example embodiment in that the switching control means 110 determines, based on importance, analysis target data to be discarded.

The importance judging means 104 judges the importance of each portion of analysis target data. The importance is, for example, the degree of priority of processing of an analysis target contained in the analysis target data, and corresponds to the importance or the riskiness of a step indicated in the analysis target data. The importance can be judged based on an AI-based analysis of the result of detection and identification of an analysis target carried out by the first processing section 20 or the second processing section 30. Note that the importance may be judged with use of a trained model which has learned importance with respect to a result of the detection of an analysis target.

For example, the importance judging means 104 may judge the importance of each portion of analysis target data by inputting, to the trained model, input data in which the calculated features of respective portions of the analysis target data are concatenated. The trained model to be used may receive, as an input, the input data in which the features of the respective portions are concatenated, generate, based on the input data, relatedness information which indicates the relatedness between the features of the respective portions, and output the importance of each of regions based on the relatedness information and the input data. According to an example aspect, the relatedness information indicates, regarding the importance of each of the regions, a degree to which each of the regions is related to another region, which is other than that region. In other words, the relatedness information indicates the relatedness of the regions such that for each of the regions, the relatedness to a region which is necessary to judge the importance of that region increases and the relatedness to a region which is not necessary to judge the importance of the certain region decreases. Examples of such relatedness information include an attention weight used in an attention mechanism such as self-attention mechanism. The trained model includes, for example, one or more layers for generating the relatedness information based on input data and one or more layers for generating the importance of each region based on the relatedness information and the input data. The trained model can be trained by, for example, reinforcement learning in which an input image for training and an analysis engine are used, the input image having attached thereto a label which indicates an analysis result, the analysis engine analyzing the input image with use of the importance.

The switching control means 110 determines, based on the importance judged by the importance judging means 104, an analysis target data portion of analysis target data portion that is to be discard. For example, the switching control means 110 determines that an analysis target data portion of relatively high importance should be processed and an analysis target data portion of relatively low importance should be discarded. This makes it possible to obtain an analysis result based on an analysis target data portion of high importance.

Although the fourth example embodiment is the processing control system 100 in the above description, the fourth example embodiment may be a processing control apparatus into which the processing control system 100 in accordance with the fourth example embodiment is incorporated. Further, the operation of the processing control system 100 in accordance with the fourth example embodiment may be a processing control method in accordance with the fourth example embodiment.

### Fifth Example Embodiment

The following description will discuss a fifth example embodiment of the present invention in detail with reference to the drawings. The same reference sign is assigned to a component that has the same function as the component described in the first example embodiment, and the description thereof is not repeated.

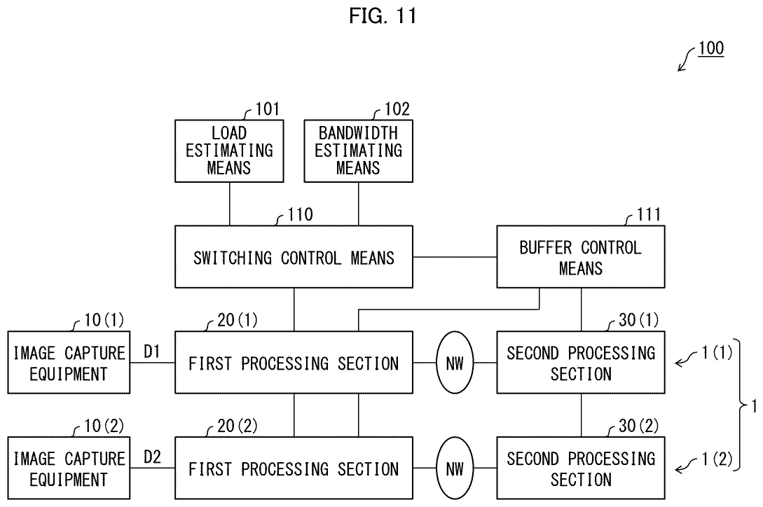

FIG. 11 is a block diagram illustrating an example configuration of a processing control system 100 in accordance with the fifth example embodiment. The processing control system 100 includes a load estimating means 101, a bandwidth estimating means 102, a switching control means 110, and a buffer control means 111, and controls processing systems 1(1) and 1(2). The processing control system 100 in accordance with the present example embodiment differs from that of the second example embodiment in that the buffer control means 111 is included.

The buffer control means 111 determines a buffer frame quantity which is equal to or smaller than the predetermined number of frames that constitute a unit frame set. With appropriate setting of the buffer frame quantity, it is possible to effectively utilize the resources of the first processing section 20 and the second processing section 30.

The buffer control means 111 causes one of the first processing section 20 and the second processing section 30 that is not analyzing analysis target data to buffer frames the number of which is the buffer frame quantity. Upon switching by which the processing section that is not processing the analysis target data is switched so as to analyze the analysis target data, the buffer control means 111 causes that processing section to analyze the analysis target data with use of frames which are buffered and the number of which is the buffer frame quantity. This makes it possible to finish an analysis of a unit frame set with use of buffered frames even in a case of switching of the analysis in the middle of the unit frame set.

For example, in a case where the second processing section 30 is analyzing a frame, the first processing section 20 buffers frames the number of which is the buffer frame quantity. Upon switching of the analysis of the analysis target data from the second processing section 30 to the first processing section 20, the first processing section 20 uses the buffered frames to analyze the analysis target data.

The buffer control means 111 may determine the buffer frame quantity based on a communication bandwidth estimated by the bandwidth estimating means 102. For example, if the communication bandwidth is small, then the buffer frame quantity is increased, and if the communication bandwidth is great, then the buffer frame quantity is reduced. This makes it possible to mitigate frame loss even in a case where a projected communication bandwidth is small.

The buffer control means 111 may determine the buffer frame quantity based on a communication bandwidth allocated for transmitting analysis target data. For example, if the allocated communication bandwidth is great, then the buffer frame quantity is increased, and if the allocated communication bandwidth is small, then the buffer frame quantity is reduced. This makes it possible to prevent omission in the processing of an analysis target data portion which is allocated a great communication bandwidth and which is considered to be important.

Although the fifth example embodiment is the processing control system 100 in the above description, the fifth example embodiment may be a processing control apparatus into which the processing control system 100 in accordance with the fifth example embodiment is incorporated. Further, the operation of the processing control system 100 in accordance with the fifth example embodiment may be a processing control method in accordance with the fifth example embodiment.

### Sixth Example Embodiment

The following description will discuss a sixth example embodiment of the present invention in detail with reference to the drawings. The same reference sign is assigned to a component that has the same function as the component described in the first example embodiment, and the description thereof is not repeated.

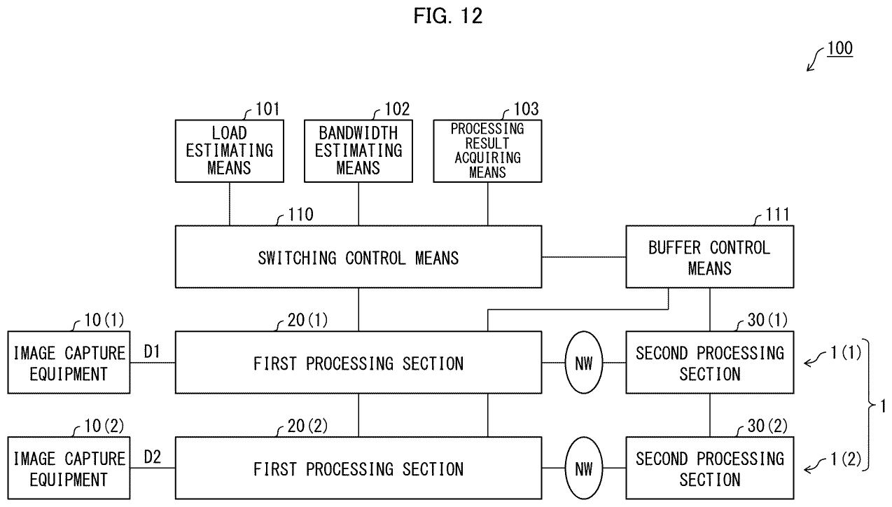

FIG. 12 is a block diagram illustrating an example configuration of a processing control system 100 in accordance with the sixth example embodiment. The processing control system 100 includes a load estimating means 101, a bandwidth estimating means 102, a processing result acquiring means 103, a switching control means 110, and a buffer control means 111, and controls processing systems 1(1) and 1(2). The processing control system 100 in accordance with the present example embodiment differs from that of the fifth example embodiment in that the buffer control means 111 determines the buffer frame quantity based on reliability.

As described above, the processing result acquiring means 103 acquires the reliability of processing of analysis target data, the reliability being judged by the first processing section 20 or the second processing section 30.

The buffer control means 111 determines the buffer frame quantity based on reliability acquired by the processing result acquiring means 103. For example, the buffer control means 111 increases the buffer frame quantity in a case of high reliability of processing of analysis target data, and reduces the buffer frame quantity in a case of low reliability of the processing. This makes it possible to prevent the loss of analysis target data of high reliability.

Although the sixth example embodiment is the processing control system 100 in the above description, the sixth example embodiment may be a processing control apparatus into which the processing control system 100 in accordance with the sixth example embodiment is incorporated. Further, the operation of the processing control system 100 in accordance with the sixth example embodiment may be a processing control method in accordance with the sixth example embodiment.

### Seventh Example Embodiment

The following description will discuss a seventh example embodiment of the present invention in detail with reference to the drawings. The same reference sign is assigned to a component that has the same function as the component described in the first example embodiment, and the description thereof is not repeated.

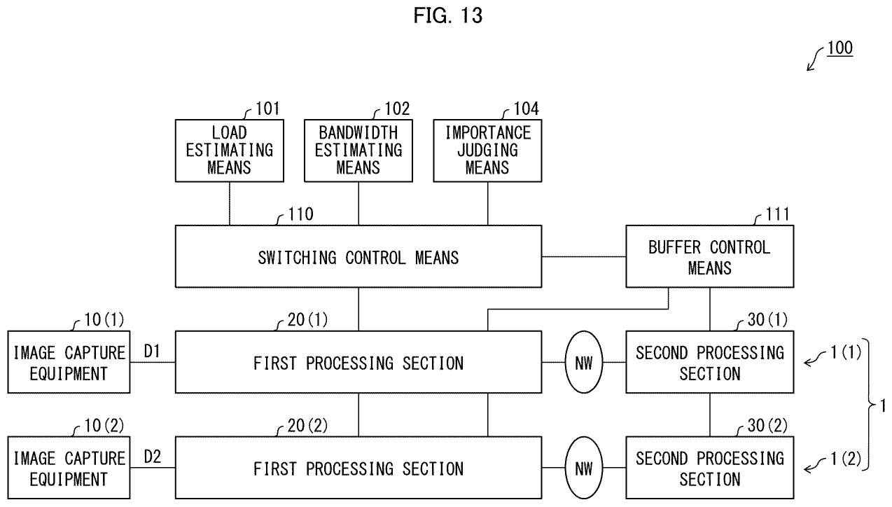

FIG. 13 is a block diagram illustrating an example configuration of a processing control system 100 in accordance with the seventh example embodiment. The processing control system 100 in accordance with the seventh example embodiment includes a load estimating means 101, a bandwidth estimating means 102, an importance judging means 104, a switching control means 110, and a buffer control means 111, and controls processing systems 1(1) and 1(2). The processing control system 100 in accordance with the present example embodiment differs from that of the fifth example embodiment in that the buffer control means 111 determines the buffer frame quantity based on importance.

As described above, the importance judging means 104 judges the importance of each portion of analysis target data. The buffer control means 111 determines the buffer frame quantity based on judged by the importance judging means 104. For example, the buffer control means 111 increases the buffer frame quantity in a case of analysis target data of high importance, and reduces the buffer frame quantity in a case of analysis target data of low importance. This makes it possible to prevent the loss of analysis target data of high importance.

Although the seventh example embodiment is the processing control system 100 in the above description, the seventh example embodiment may be a processing control apparatus into which the processing control system 100 in accordance with the seventh example embodiment is incorporated. Further, the operation of the processing control system 100 in accordance with the seventh example embodiment may be a processing control method in accordance with the seventh example embodiment.

### Eighth Example Embodiment

The following description will discuss an eighth example embodiment of the present invention in detail with reference to the drawings. The same reference sign is assigned to a component that has the same function as the component described in the first example embodiment, and the description thereof is not repeated.

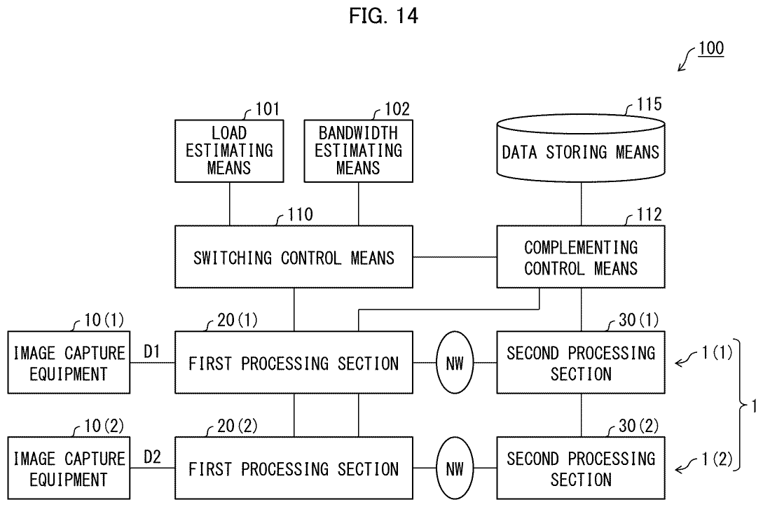

FIG. 14 is a block diagram illustrating an example configuration of a processing control system 100 in accordance with the eighth example embodiment. The processing control system 100 in accordance with the eighth example embodiment includes a load estimating means 101, a bandwidth estimating means 102, a switching control means 110, a complementing control means 112, and a data storing means 115, and controls processing systems 1(1) and 1(2). The processing control system 100 in accordance with the present example embodiment differs from that of the second example embodiment in that the complementing control means 112 is included.

Upon switching by which the first processing section 20 is switched so as to process analysis target data from the state of not being processing the analysis target data, the complementing control means 112 causes the first processing section 20 to complement a frame which was being processed in a unit frame set before the switching, and upon switching by which the second processing section 30 is switched so as to process analysis target data from the state of not being processing the analysis target data, the complementing control means 112 causes the second processing section 30 to complement a frame which was being processed in a unit frame set before the switching. This makes it possible to analyze a unit frame set by complementing a frame, even in a case of switching of the analysis in the middle of the unit frame set.

The data storing means 115 may be disposed so as to be external to the second processing section 30 and store the result of processing carried out by the second processing section 30. Note that the result of processing carried out by the second processing section 30 may be stored in the second processing section 30 itself instead of the data storing means 115. Hereinafter, regardless of the presence or absence of the data storing means 115, the expression shall be such that the second processing section 30 stores a result of processing, for the sake of plainness.

Similarly, the data storing means 115 may be disposed so as to be external to the first processing section 20 and store the result of processing carried out by the first processing section 20. Note that the result of processing carried out by the first processing section 20 may be stored in the first processing section 20 itself instead of the data storing means 115. Hereinafter, regardless of the presence or absence of the data storing means 115, the expression shall be such that the first processing section 20 stores a result of processing, for the sake of plainness.

Examples of a method for complementing a unit frame set can include (1) replication and (2) extraction, as below. In a case of the replication, the data storing means 115 is omitted.

(1) The complementing control means 112 causes a frame which was being processed before switching to be complemented, by replication of a frame which is to be processed first after the switching. As an example, let the case be considered where immediately after the first processing section 20 processes the i-th frame of a unit frame set, the process of analysis target data is switched to an analysis carried out by the second processing section 30. In this case, the second processing section 30 complements the unit frame set by replicating the “i+1”-th frame to be processed first after the switching, to prepare the first to the i-th frames, and thus processes the unit frame set. This makes it possible to reliably analyze a unit frame set.

Similarly, let the case be considered where immediately after the second processing section 30 processes the i-th frame of a unit frame set, the analysis of analysis target data is switched to the first processing section 20. In this case, the first processing section 20 complements the unit frame set by replicating the “i+1”-th frame to be processed first after the switching, to prepare the first to the i-th frames, and thus analyzes the unit frame set. This makes it possible to reliably analyze a unit frame set.

(2) The first processing section 20 and the second processing section 30 store results of processing of frames. The complementing control means 112 causes a frame which was being processed before switching to be complemented, by extraction, from these stored results of processing, of a result of processing which is similar to the result of processing of a frame to be processed first after the switching. As an example, let the case be considered where immediately after the first processing section 20 processes the i-th frame of a unit frame set, the process of analysis target data is switched to the second processing section 30. In this case, the second processing section 30 complements frames which constitute a unit frame set by extracting a previous processing result which is similar to the result of processing of the “i+1”-th frame to be processed first after the switching, to prepare the first to the i-th frame, and thus analyzes the unit frame set. This makes it possible to reliably analyze a unit frame set.

Similarly, let the case be considered where immediately after the second processing section 30 processes the i-th frame of a unit frame set, the analysis of analysis target data is switched to the first processing section 20. In this case, the first processing section 20 complements frames which constitute a unit frame set by extracting a previous processing result which is similar to the result of processing of the “i+1”-th frame to be processed first after the switching, to prepare the first to the i-th frame, and thus analyzes the unit frame set. This makes it possible to reliably analyze a unit frame set.

Although the eighth example embodiment is the processing control system 100 in the above description, the eighth example embodiment may be a processing control apparatus into which the processing control system 100 in accordance with the eighth example embodiment is incorporated. Further, the operation of the processing control system 100 in accordance with the eighth example embodiment may be a processing control method in accordance with the eighth example embodiment.

### Ninth Example Embodiment

The following description will discuss a processing control system 100 in accordance with a ninth example embodiment of the present invention in detail. The processing control system 100 in accordance with the ninth example embodiment is described with use of FIG. 14.

According to the ninth example embodiment of the present invention, a complementing control means 112 determines an upper frame quantity limit, which is the upper limit of the number of frames to be complemented. In a case where the number of frames to be complemented is greater than the upper frame quantity limit, the complementing control means 112 does not cause the frame which was being processed before switching to be complemented.

As an example, let the case be considered where the upper frame quantity limit is p, and immediately after the first processing section 20 processes the i-th frame of a unit frame set, the analysis of analysis target data is switched to the second processing section 30. In this case, a value of “N−i”, which is the value obtained by subtracting i from the predetermined number N of the unit frame set, is the number of frames to be complemented. If the number “N−i” of frames to be complemented is not greater than p, then the second processing section 30 complements the frames to analyze the unit frame set. If the number “N−i” of frames to be complemented is greater than p, then the second processing section 30 does not complement a frame and does not analyze this unit frame set.

Similarly, let the case be considered where the upper frame quantity limit is p, and immediately after the second processing section 30 the first processing section 20 processes the i-th frame of a unit frame set, the analysis of analysis target data is switched to the first processing section 20. In this case, a value of “N−i”, which is the value obtained by subtracting i from the predetermined number N of the unit frame set, is the number of frames to be complemented. If the number “N−i” of frames to be complemented is not greater than p, then the first processing section 20 complements the frames to analyze the unit frame set. If the number “N−i” of frames to be complemented is greater than p, then the first processing section 20 does not complement a frame and does not analyze this unit frame set.

The complementing control means 112 may determine the upper frame quantity limit based on an allocated communication bandwidth. For example, the complementing control means 112 increases the upper frame quantity limit in a case where a communication bandwidth allocated for transmitting an analysis target data portion is great, and reduces the upper frame quantity limit in a case where the communication bandwidth allocated for transmitting an analysis target data portion is small. This makes it possible to prevent omission in the analysis of an analysis target data portion which is allocated a great communication bandwidth and which is considered to be important.

Although the ninth example embodiment is the processing control system 100 in the above description, the ninth example embodiment may be a processing control apparatus into which the processing control system 100 in accordance with the ninth example embodiment is incorporated. Further, the operation of the processing control system 100 in accordance with the ninth example embodiment may be a processing control method in accordance with the ninth example embodiment.

### Tenth Example Embodiment

The following description will discuss a tenth example embodiment of the present invention in detail with reference to the drawings. The same reference sign is assigned to a component that has the same function as the component described in the first example embodiment, and the description thereof is not repeated.

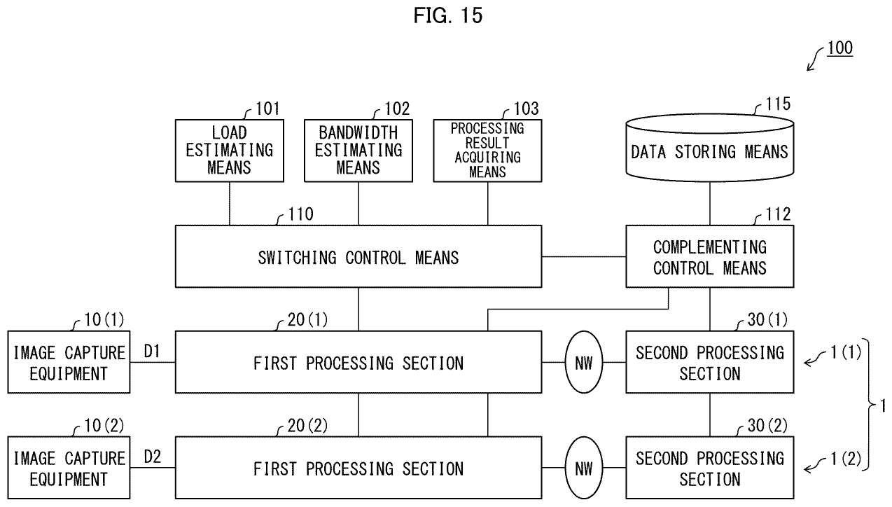

FIG. 15 is a block diagram illustrating an example configuration of a processing control system 100 in accordance with the tenth example embodiment. The processing control system 100 includes a load estimating means 101, a bandwidth estimating means 102, a processing result acquiring means 103, a switching control means 110, and a complementing control means 112, and controls processing systems 1(1) and 1(2). The processing control system 100 in accordance with the present example embodiment differs from that of the eighth example embodiment in that the complementing control means 112 determines, based on reliability, the upper frame quantity limit for complementation.

The processing result acquiring means 103 acquires the reliability of processing of analysis target data, and the complementing control means 112 determines the upper frame quantity limit based on the reliability acquired by the processing result acquiring means 103. For example, the complementing control means 112 increases the upper frame quantity limit in a case where the reliability of processing of analysis target data is high, and reduces the upper frame quantity limit in a case where the reliability of processing of the analysis target data is low. This makes it possible to prevent the loss of analysis target data of high reliability.

Although the tenth example embodiment is the processing control system 100 in the above description, the tenth example embodiment may be a processing control apparatus into which the processing control system 100 in accordance with tenth example embodiment is incorporated. Further, the operation of the processing control system 100 in accordance with the tenth example embodiment may be a processing control method in accordance with the tenth example embodiment.

### Eleventh Example Embodiment

The following description will discuss an eleventh example embodiment of the present invention in detail with reference to the drawings. The same reference sign is assigned to a component that has the same function as the component described in the first example embodiment, and the description thereof is not repeated.

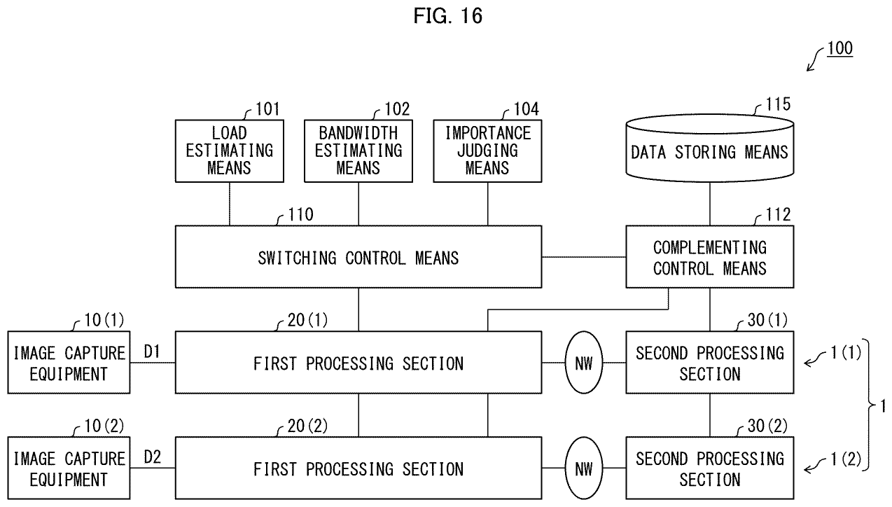

FIG. 16 is a block diagram illustrating an example configuration of a processing control system 100 in accordance with the eleventh example embodiment. The processing control system 100 includes a load estimating means 101, a bandwidth estimating means 102, an importance judging means 104, a switching control means 110, a complementing control means 112, and a data storing means 115, and controls processing systems 1(1) and 1(2). The processing control system 100 in accordance with the present example embodiment differs from that of the eighth example embodiment in that the complementing control means 112 determines, based on importance, the upper frame quantity limit for complementation.

The importance judging means 104 determines the importance of each portion of analysis target data, and the complementing control means 112 determines the upper frame quantity limit based on the importance determined by the importance judging means 104. For example, the complementing control means 112 increases the upper frame quantity limit in a case where the importance of the analysis target data is high, and reduces the upper frame quantity limit in a case where the importance of the analysis target data is low. This makes it possible to prevent the loss of analysis target data of high importance.

Although the eleventh example embodiment is the processing control system 100 in the above description, the eleventh example embodiment may be a processing control apparatus into which the processing control system 100 in accordance with the eleventh example embodiment is incorporated. Further, the operation of the processing control system 100 in accordance with the eleventh example embodiment may be a processing control method in accordance with the ninth example embodiment.

### Twelfth Example Embodiment

The following description will discuss a twelfth example embodiment of the present invention in detail with reference to the drawings. The same reference sign is assigned to a component that has the same function as the component described in the first example embodiment, and the description thereof is not repeated.

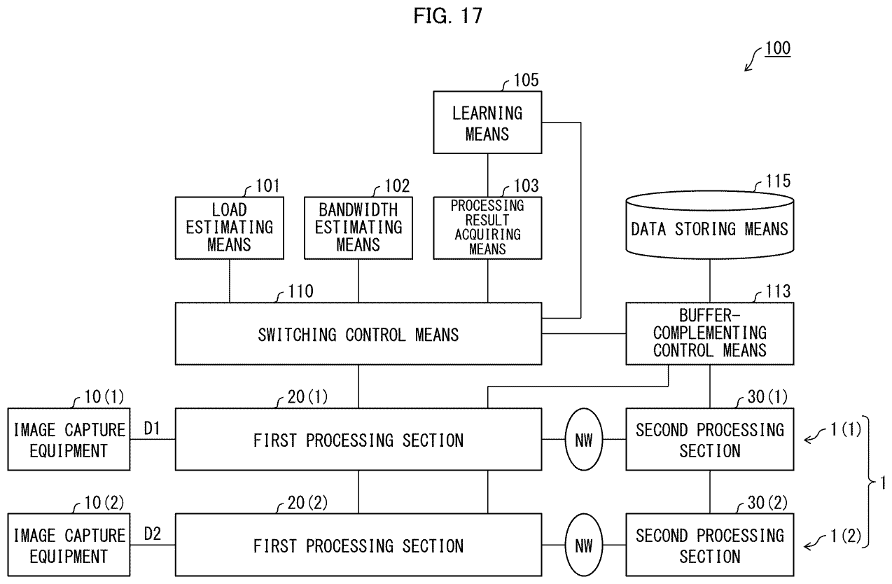

FIG. 17 is a block diagram illustrating an example configuration of a processing control system 100 in accordance with a twelfth example embodiment. The processing control system 100 includes a load estimating means 101, a bandwidth estimating means 102, a learning means 105, a switching control means 110, a buffer-complementing control means 113, and a data storing means 115, and controls processing systems 1(1) and 1(2). The processing control system 100 in accordance with the present example embodiment differs from those of the fifth and eighth example embodiments in that the buffer-complementing control means 113 is included.

The buffer-complementing control means 113 has combined functions of the buffer control means 111 and the complementing control means 112, and is capable of switching between the analysis target data buffering control by the buffer control means 111 and the analysis target data complementing control by the complementing control means 112 to carry out the control. Note that the processing control system 100 may include the buffer control means 111 and the complementing control means 112 instead of the buffer-complementing control means 113.

The learning means 105 learns, based on a communication bandwidth estimated by the bandwidth estimating means 102, which control to use, buffering control or complementing control, and how to determine a buffer frame quantity in the buffering control and an upper frame quantity limit in the complementing control. Based on this learning result, the learning means 105 makes selection between the buffering control and the complementing control.

Although the twelfth example embodiment is the processing control system 100 in the above description, the twelfth example embodiment may be a processing control apparatus into which the processing control system 100 in accordance with the twelfth example embodiment is incorporated. Further, the operation of the processing control system 100 in accordance with the twelfth example embodiment may be a processing control method in accordance with the twelfth example embodiment.

The present disclosure is not limited to the example embodiments above, but can be altered by a skilled person in the art in various ways. Any example embodiment derived by appropriately combining configurations, operations, and processes disclosed in differing example embodiments is also within the technical scope of the present disclosure. In addition, any embodiment derived by appropriately altering the orders of operations and processes disclosed in differing example embodiments is within the technical scope of the present disclosure.

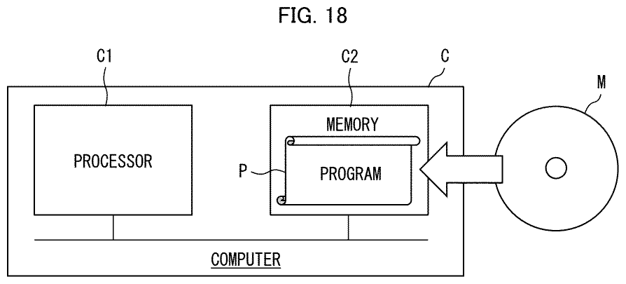

Each of the configurations in accordance with the first to the twelfth example embodiments may be implemented by any of (1) one or more pieces of hardware, (2) one or more pieces of software, (3) a combination of hardware and software, and (4) a cloud server. Each of the apparatuses, each of the functions and each of the processes may be implemented by a single computer which includes at least one processor and at least one memory. An example (hereinafter, computer C) of such a computer is illustrated in FIG. 18. For example, a program for carrying out the processing control methods described in the first to the twelfth example embodiments is stored in a memory C2, and a processor C retrieves a program P stored in the memory C2 and executes the program P, so that the functions of the first to the twelfth example embodiments may be implemented.

The program P includes an instruction set for, upon loading of the program P into a computer C, causing the computer C to carry out one or more functions described in the first to the twelfth example embodiments. The program P is stored in the memory C2. Examples of the processor C1 can include a central processing unit (CPU). Examples of the memory 1602 can include a read only memory (ROM), a random access memory (RAM), a flash memory, and a solid state drive (SSD).

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can obtain the program P also via such a transmission medium.

The present disclosure is not limited by the above example embodiments. That is, the present invention can apply, within the scope of the present disclosure, various example aspects that could be understood by a person skilled in the art. The whole or part of the example embodiments disclosed above can be described as, but not limited to, the following supplementary notes.

### Supplementary Note 1

A processing control system for controlling a first processing section for acquiring analysis target data from image capture equipment and a second processing section capable of communicating with the first processing section,
the first processing section being configured to process at least part of the analysis target data and transmit at least part of the analysis target data to the second processing section, and
the second processing section being configured to process the at least part of the analysis target data that is transmitted from the first processing section, in which
the processing control system includes:
   a load estimating means for estimating a processing load of the analysis target data in the first processing section;
   a bandwidth estimating means for estimating a communication bandwidth of communication between the first processing section and the second processing section; and
   a switching control means for carrying out, based on the processing load estimated and the communication bandwidth estimated, control of which processing section analyzes the analysis target data, the first processing section or the second processing section.

### Supplementary Note 2

The processing control system described in supplementary note 1, in which the switching control means is configured to determine, based on the communication bandwidth estimated, an analysis target data portion of the analysis target data that is to be discarded.

### Supplementary Note 3

The processing control system described in supplementary note 1, in which the analysis target data has a plurality of chronologically successive frames,
the first processing section and the second processing section process the analysis target data in unit frame sets, each of which is a processing unit and is constituted by a predetermined number of frames,
the processing control system further includes a buffer control means, and
the buffer control means is configured to:
   determine a buffer frame quantity which is equal to or smaller than the predetermined number; and
   cause one of the first processing section and the second processing section that is not processing the analysis target data to buffer frames the number of which is the buffer frame quantity, and upon switching of processing of the analysis target data to the one, causes the one to which the switching is made to analyze the analysis target data with use of frames which are buffered and the number of which is the buffer frame quantity.

### Supplementary Note 3A

A processing control system for controlling a first processing section and a second processing section which is capable of communicating with the first processing section and which shares an analysis of analysis target data with the first processing section,
the first processing section being configured to analyze at least part of the analysis target data and transmit at least part of the analysis target data to the second processing section,
the second processing section being configured to analyze the at least part of the analysis target data that is transmitted from the first processing section, in which
the processing control system includes:
   a switching control means for carrying out control of which processing section analyzes the analysis target data, the first processing section or the second processing section; and
   a buffer control means for causing one of the first processing section and the second processing section that is not analyzing the analysis target data to buffer the analysis target data.

### Supplementary Note 3B

The processing control system described in supplementary note 3A, in which the processing control system further includes:
a load estimating means for estimating a processing load of the analysis target data in the first processing section; and
a bandwidth estimating means for estimating a communication bandwidth of communication between the first processing section and the second processing section, and
the switching control means is configured to
carry out, based on the processing load estimated and the communication bandwidth estimated, control of which processing section analyzes the analysis target data, the first processing section or the second processing section.

### Supplementary Note 3C

The processing control system described in supplementary note 3A or 3B, in which the analysis target data has a plurality of chronologically successive frames,
the first processing section and the second processing section process the analysis target data in unit frame sets, each of which is a processing unit and is constituted by a predetermined number of frames, and
the buffer control means is configured to:
   determine a buffer frame quantity which is equal to or smaller than the predetermined number; and
   upon switching of processing of the analysis target data to one of the first processing section and the second processing section that is not processing the analysis target data, cause the one to which the switching is made to analyze the analysis target data with use of frames which are buffered and the number of which is the buffer frame quantity.

### Supplementary Note 4

The processing control system described in supplementary note 3 or 3C, in which the buffer control means is configured to determine the buffer frame quantity based on the communication bandwidth estimated.

### Supplementary Note 5

The processing control system described in supplementary note 3 or 3C, in which the processing control system further includes an importance judging means for judging importance of each portion of the analysis target data, and
the buffer control means is configured to determine the buffer frame quantity based on the importance.

### Supplementary Note 6

The processing control system described in supplementary note 1, in which the analysis target data has a plurality of chronologically successive frames,
the first processing section and the second processing section process the analysis target data in unit frame sets, each of which is a processing unit and is constituted by a predetermined number of frames,
the processing control system further includes a complementing control means, and
upon switching by which the first processing section is switched so as to process the analysis target data from a state of not being processing the analysis target data, the complementing control means is configured to cause the first processing section to complement a frame which was being processed in a unit frame set before the switching, and upon switching by which the second processing section is switched so as to process the analysis target data from a state of not being processing the analysis target data, the complementing control means is configured to cause the second processing section to complement a frame which was being processed in a unit frame set before the switching.

### Supplementary Note 7

The processing control system described in supplementary note 6, in which the complementing control means is configured to cause the frame which was being processed before the switching to be complemented, by replication of a frame which is to be processed first after the switching.

### Supplementary Note 8

A processing control apparatus for controlling a first processing section for acquiring analysis target data from image capture equipment and a second processing section capable of communicating with the first processing section,
the first processing section being configured to process at least part of the analysis target data and transmit at least part of the analysis target data to the second processing section, and
the second processing section being configured to process the at least part of the analysis target data that is transmitted from the first processing section, in which
the processing control apparatus includes:
   a load estimating section for estimating a processing load of the analysis target data in the first processing section;
   a bandwidth estimating section for estimating a communication bandwidth of communication between the first processing section and the second processing section; and
   a switching control section for carrying out, based on the processing load estimated and the communication bandwidth estimated, control of which processing section analyzes the analysis target data, the first processing section or the second processing section.

### Supplementary Note 9

The processing control apparatus described in supplementary note 8, in which the switching control section is configured to determine, based on the communication bandwidth estimated, an analysis target data portion of the analysis target data that is to be discarded.

### Supplementary Note 10

The processing control apparatus described in supplementary note 8, in which the analysis target data has a plurality of chronologically successive frames,
the first processing section and the second processing section process the analysis target data in unit frame sets, each of which is a processing unit and is constituted by a predetermined number of frames,
the processing control apparatus further includes a buffering control section, and
the buffering control section is configured to:
   determine a buffer frame quantity which is equal to or smaller than the predetermined number; and
   cause one of the first processing section and the second processing section that is not processing the analysis target data to buffer frames the number of which is the buffer frame quantity, and upon switching of processing of the analysis target data to the one, causes the one to which the switching is made to analyze the analysis target data with use of frames which are buffered and the number of which is the buffer frame quantity.

### Supplementary Note 10A

A processing control apparatus for controlling a first processing section and a second processing section which is capable of communicating with the first processing section and which shares an analysis of analysis target data with the first processing section,
the first processing section being configured to analyze at least part of the analysis target data and transmit at least part of the analysis target data to the second processing section,
the second processing section being configured to analyze the at least part of the analysis target data that is transmitted from the first processing section, in which
the processing control apparatus includes:
   a switching control section for carrying out control of which processing section analyzes the analysis target data, the first processing section or the second processing section; and
   a buffer control section for causing one of the first processing section and the second processing section that is not analyzing the analysis target data to buffer the analysis target data.

### Supplementary Note 10B

The processing control apparatus described in supplementary note 10A, in which the processing control apparatus further includes:
a load estimating section for estimating a processing load of the analysis target data in the first processing section; and
a bandwidth estimating section for estimating a communication bandwidth of communication between the first processing section and the second processing section, and
the switching control section is configured to
carry out, based on the processing load estimated and the communication bandwidth estimated, control of which processing section analyzes the analysis target data, the first processing section or the second processing section.

### Supplementary Note 10C

The processing control apparatus described in supplementary note 10A or 10B, in which the analysis target data has a plurality of chronologically successive frames,
the first processing section and the second processing section process the analysis target data in unit frame sets, each of which is a processing unit and is constituted by a predetermined number of frames, and
the buffer control section is configured to:
   determine a buffer frame quantity which is equal to or smaller than the predetermined number; and
   upon switching of processing of the analysis target data to one of the first processing section and the second processing section that is not processing the analysis target data, cause the one to which the switching is made to analyze the analysis target data with use of frames which are buffered and the number of which is the buffer frame quantity.

### Supplementary Note 11

The processing control apparatus described in supplementary note 10 or 10C, in which the buffering control section is configured to determine the buffer frame quantity based on the communication bandwidth estimated.

### Supplementary Note 12

The processing control apparatus described in supplementary note 10 or 10C, in which the processing control apparatus further includes an importance judging section for judging importance of each portion of the analysis target data, and
the buffering control section is configured to determine the buffer frame quantity based on the importance.

### Supplementary Note 13

The processing control apparatus described in supplementary note 8, in which the analysis target data has a plurality of chronologically successive frames,
the first processing section and the second processing section process the analysis target data in unit frame sets, each of which is a processing unit and is constituted by a predetermined number of frames, and
the processing control apparatus further includes:
   a complementing process control section configured to, upon switching by which the first processing section is switched so as to process the analysis target data from a state of not being processing the analysis target data, cause the first processing section to complement a frame which was being processed in a unit frame set before the switching, and upon switching by which the second processing section is switched so as to process the analysis target data from a state of not being processing the analysis target data, cause the second processing section to complement a frame which was being processed in a unit frame set before the switching.

### Supplementary Note 14

The processing control apparatus described in supplementary note 13, in which the complementing process control section is configured to cause the frame which was being processed before the switching to be complemented, by replication of a frame which is to be processed first after the switching.

### Supplementary Note 15

A processing control method for controlling a first processing section for acquiring analysis target data from image capture equipment and a second processing section capable of communicating with the first processing section,
the first processing section being configured to process at least part of the analysis target data and transmit at least part of the analysis target data to the second processing section, and
the second processing section being configured to process the at least part of the analysis target data that is transmitted from the first processing section, in which
the processing control method includes:
   a load estimating means estimating a processing load of the analysis target data in the first processing section;
   a bandwidth estimating means estimating a communication bandwidth of communication between the first processing section and the second processing section; and
   a switching control means carrying out, based on the processing load estimated and the communication bandwidth estimated, control of which processing section analyzes the analysis target data, the first processing section or the second processing section.

### Supplementary Note 16

The processing control method described in supplementary note 15, in which the processing control method further includes the switching control means determining, based on the communication bandwidth estimated, an analysis target data portion of the analysis target data that is to be discarded.

### Supplementary Note 17

The processing control method described in supplementary note 15, in which the analysis target data has a plurality of chronologically successive frames,
the first processing section and the second processing section process the analysis target data in unit frame sets, each of which is a processing unit and is constituted by a predetermined number of frames, and
the processing control method further includes:
   the buffer control means determining a buffer frame quantity which is equal to or smaller than the predetermined number; and
   the buffer control means causing one of the first processing section and the second processing section that is not processing the analysis target data to buffer frames the number of which is the buffer frame quantity, and upon switching of processing of the analysis target data to the one, causing the one to which the switching is made to analyze the analysis target data with use of frames which are buffered and the number of which is the buffer frame quantity.

### Supplementary Note 17A

A processing control method for controlling a first processing section and a second processing section which is capable of communicating with the first processing section and which shares an analysis of analysis target data with the first processing section, in which
a switching control process of carrying out control of which processing section analyzes the analysis target data, the first processing section or the second processing section, and
a buffer control process of causing one of the first processing section and the second processing section that is not analyzing the analysis target data to buffer the analysis target data are carried out, and
the first processing section is configured to analyze at least part of the analysis target data and transmit at least part of the analysis target data to the second processing section, and
the second processing section is configured to analyze the at least part of the analysis target data that is transmitted from the first processing section.

### Supplementary Note 17B

The processing control method described in supplementary note 17A, in which
a load estimating process of estimating a processing load of the analysis target data in the first processing section and
a bandwidth estimating process of estimating a communication bandwidth of communication between the first processing section and the second processing section are carried out, and
in the switching control process,
control of which processing section analyzes the analysis target data, the first processing section or the second processing section is carried out based on the processing load estimated and the communication bandwidth estimated.

### Supplementary Note 17C

The processing control method described in supplementary note 17A or 17B, in which the analysis target data has a plurality of chronologically successive frames,
the first processing section and the second processing section process the analysis target data in unit frame sets, each of which is a processing unit and is constituted by a predetermined number of frames, and
in the buffer control process,
   a buffer frame quantity which is equal to or smaller than the predetermined number is determined, and
   upon switching of processing of the analysis target data to one of the first processing section and the second processing section that is not processing the analysis target data, the one to which the switching is made is caused to analyze the analysis target data with use of frames which are buffered and the number of which is the buffer frame quantity.

### Supplementary Note 18

The processing control method described in supplementary note 17 or 17C, in which the processing control method further includes the buffer control means determining the buffer frame quantity based on the communication bandwidth estimated.

### Supplementary Note 19

The processing control method described in supplementary note 17 or 17C, the processing control method further includes:
an importance judging means judging importance of each portion of the analysis target data; and
the buffer control means determining the buffer frame quantity based on the importance.

### Supplementary Note 20

The processing control method described in supplementary note 15, in which the analysis target data has a plurality of chronologically successive frames,
the first processing section and the second processing section process the analysis target data in unit frame sets, each of which is a processing unit and is constituted by a predetermined number of frames, and
the processing control method further includes a complementing control means causing, upon switching by which the first processing section is switched so as to process the analysis target data from a state of not being processing the analysis target data, the first processing section to complement a frame which was being processed in a unit frame set before the switching, and causing, upon switching by which the second processing section is switched so as to process the analysis target data from a state of not being processing the analysis target data, the second processing section to complement a frame which was being processed in a unit frame set before the switching.

### Supplementary Note 21

The processing control system described in supplementary note 1, in which a communication bandwidth is allocated for transmitting the analysis target data, and
the switching control means is configured to determine, based on the communication bandwidth allocated, an analysis target data portion of the analysis target data that is to be discarded.

### Supplementary Note 22

The processing control system described in supplementary note 1, in which the processing control system further includes a processing result acquiring means for acquiring reliability of processing of the analysis target data, and
the switching control means is configured to determine, based on the reliability, an analysis target data portion of the analysis target data that is to be discarded.

### Supplementary Note 23

The processing control system described in supplementary note 1, in which the processing control system further includes an importance judging means for judging importance of each portion of the analysis target data, and
the switching control means is configured to determine, based on the importance, an analysis target data portion of the analysis target data that is to be discarded.

### Supplementary Note 24

The processing control system described in supplementary note 3 or 3C, in which a communication bandwidth is allocated for transmitting the analysis target data, and
the buffer control means is configured to determine the buffer frame quantity based on the communication bandwidth allocated.

### Supplementary Note 25

The processing control system described in supplementary note 3 or 3C, in which the processing control system further includes a processing result acquiring means for acquiring reliability of processing of the analysis target data, and
the buffer control means is configured to determine the buffer frame quantity based on the reliability.

### Supplementary Note 26

The processing control system described in supplementary note 6, in which the first processing section and the second processing section store results of processing of frames, and
the complementing control means is configured to cause a frame which was being processed before the switching to be complemented, by extraction, from the results of processing stored, of a result of processing which is similar to a result of processing of a frame to be processed first after the switching.

### Supplementary Note 27

The processing control system described in supplementary note 6, in which the complementing control means is configured to:
determine an upper frame quantity limit, which is an upper limit of the number of frames to be complemented; and
prevent the frame which was being processed before the switching from being complemented, in a case where the number of frames to be complemented is greater than the upper frame quantity limit.

### Supplementary Note 28

The processing control system described in supplementary note 27, in which a communication bandwidth is allocated for transmitting the analysis target data, and
the complementing control means is configured to determine the upper frame quantity limit based on the communication bandwidth allocated.

### Supplementary Note 29

The processing control system described in supplementary note 27, in which the processing control system further includes a processing result acquiring means for acquiring reliability of processing of the analysis target data, and
the complementing control means is configured to determine the upper frame quantity limit based on the reliability.

### Supplementary Note 30

The processing control system described in supplementary note 27, in which the processing control system further includes an importance judging means for judging importance of each portion of the analysis target data, and
the complementing control means is configured to determine the upper frame quantity limit based on the importance.

### Supplementary Note 31

The processing control system described above can further be expressed as follows.

A processing control system for controlling a first processing section and a second processing section capable of communicating with the first processing section,
the first processing section being configured to analyze at least part of analysis target data and transmit at least part of the analysis target data to the second processing section,
the second processing section being configured to analyze the at least part of the analysis target data that is transmitted from the first processing section, in which
the processing control system includes
at least one processor, the at least one processor carries out:
   a switching control process of carrying out control of which processing section analyzes the analysis target data, the first processing section or the second processing section; and
   a buffer control process of causing one of the first processing section and the second processing section that is not analyzing the analysis target data to buffer the analysis target data.

This processing control system may further include at least one memory, and this memory may have stored therein a program for causing the at least one processor to carry out the switching control process and the buffer control process. Further, a computer-readable non-transitory tangible recording medium may have recorded thereon this program.

### Supplementary Note 32

The processing control apparatus described above can further be expressed as follows.

A processing control apparatus for controlling a first processing section and a second processing section capable of communicating with the first processing section,
the first processing section being configured to analyze at least part of analysis target data and transmit at least part of the analysis target data to the second processing section,
the second processing section being configured to analyze the at least part of the analysis target data that is transmitted from the first processing section, in which
the processing control apparatus includes
at least one processor, the at least one processor carries out:
   a switching control process of carrying out control of which processing section analyzes the analysis target data, the first processing section or the second processing section; and
   a buffer control process of causing one of the first processing section and the second processing section that is not analyzing the analysis target data to buffer the analysis target data.

This processing control apparatus may further include at least one memory, and this memory may have stored therein a program for causing the at least one processor to carry out the switching control process and the buffer control process. Further, a computer-readable non-transitory tangible recording medium may have recorded thereon this program.

### REFERENCE SIGNS LIST

100: Processing control system
101: Load estimating means
102: Bandwidth estimating means
103: Processing result acquiring means
104: Importance judging means
110: Switching control means
111: Buffer control means
112: Complementing control means
113: Buffer-complementing control means
115: Data storing means

What is claimed is:

1. A processing control system for controlling at least one first computer and section at least one second computer which is capable of communicating with the first at least one first computer,
the at least one first computer being configured to analyze at least part of analysis target data and transmit at least part of the analysis target data to the at least one second computer,
the at least one second computer being configured to analyze the at least part of the analysis target data that is transmitted from the at least one first computer, wherein
the processing control system comprises
at least one processor, and the at least one processor carries out:
a switching control process of carrying out control of which computer analyzes the analysis target data, the at least one first computer or the at least one second computer; and
a buffer control process of causing one of the at least one first computer and the at least one second computer that is not analyzing the analysis target data to buffer the analysis target data.

2. The processing control system according to claim 1, wherein
the at least one processor further carries out:
a load estimating process of estimating a processing load of the analysis target data in the at least one first computer; and
a bandwidth estimating process of estimating a communication bandwidth of communication between the at least one first computer and the at least one second computer, and
in the switching control process, the at least one processor
carries out, based on the processing load estimated and the communication bandwidth estimated, control of which computer analyzes the analysis target data, the at least one first computer or the at least one second computer.

3. The processing control system according to claim 1, wherein
the analysis target data has a plurality of chronologically successive frames,
the at least one first computer and the at least one second computer process the analysis target data in unit frame sets, each of which is a processing unit and is constituted by a predetermined number of frames, and
in the buffer control process, the at least one processor:
determines a buffer frame quantity which is equal to or smaller than the predetermined number; and
upon switching of processing of the analysis target data to one of the at least one first computer and the at least one second computer that is not processing the analysis target data, causes the one to which the switching is made to analyze the analysis target data with use of frames which are buffered and the number of which is the buffer frame quantity.

4. The processing control system according to claim 3, wherein
in the buffer control process, the at least one processor determines the buffer frame quantity based on the communication bandwidth estimated.

5. The processing control system according to claim 3, wherein
a communication bandwidth is allocated for transmitting the analysis target data, and
in the buffer control process, the at least one processor determines the buffer frame quantity based on the communication bandwidth allocated.

6. The processing control system according to claim 3, wherein
the at least one processor further carries out a processing result acquiring process of acquiring reliability of processing of the analysis target data, and
in the buffer control process, the at least one processor determines the buffer frame quantity based on the reliability.

7. The processing control system according to claim 3, wherein
the at least one processor further carries out an importance judging means process of judging importance of each portion of the analysis target data, and
in the buffer control process, the at least one processor determines the buffer frame quantity based on the importance.

8. A processing control apparatus for controlling at least one first computer and at least one second computer which is capable of communicating with the at least one first computer,
the at least one first computer being configured to analyze at least part of analysis target data and transmit at least part of the analysis target data to the second processing section at least one second computer,
the at least one second computer being configured to analyze the at least part of the analysis target data that is transmitted from the at least one first computer, wherein
the processing control apparatus comprises
at least one processor, and the at least one processor carries out:
a switching control process of carrying out control of which computer analyzes the analysis target data, the at least one first computer or the at least one second computer; and
a buffer control process of causing one of the at least one first computer and the at least one second computer that is not analyzing the analysis target data to buffer the analysis target data.

9. The processing control system according to claim 8, wherein
the analysis target data has a plurality of chronologically successive frames,
the at least one first computer and the at least one second computer process the analysis target data in unit frame sets, each of which is a processing unit and is constituted by a predetermined number of frames, and
in the buffer control process, the at least one processor:
determines a buffer frame quantity which is equal to or smaller than the predetermined number; and
upon switching of processing of the analysis target data to one of the at least one first computer and the at least one second computer that is not processing the analysis target data, causes the one to which the switching is made to analyze the analysis target data with use of frames which are buffered and the number of which is the buffer frame quantity.

10. The processing control apparatus according to claim 9, wherein
in the buffer control process, the at least one processor determines the buffer frame quantity based on a communication bandwidth estimated.

11. The processing control apparatus according to claim 9, wherein
a communication bandwidth is allocated for transmitting the analysis target data, and
in the buffer control process, the at least one processor determines the buffer frame quantity based on the communication bandwidth allocated.

12. The processing control apparatus according to claim 9, wherein
the at least one processor further carries out a processing result acquiring process of acquiring reliability of processing of the analysis target data, and
in the buffer control process, the at least one processor determines the buffer frame quantity based on the reliability.

13. The processing control apparatus according to claim 9, wherein
the at least one processor further carries out an importance judging process of judging importance of each portion of the analysis target data, and
in the buffer control process, the at least one processor determines the buffer frame quantity based on the importance.

14. A processing control method for controlling at least one first computer and at least one second computer which is capable of communicating with the at least one first computer, wherein
a switching control process of carrying out control of which computer analyzes analysis target data, the at least one first computer or the at least one second computer; and
a buffer control process of causing one of the at least one first computer and the at least one second computer that is not analyzing the analysis target data to buffer the analysis target data
are carried out by at least one processor, and
the at least one first computer is configured to analyze at least part of the analysis target data and transmit at least part of the analysis target data to the at least one second computer, and
the at least one second computer is configured to analyze the at least part of the analysis target data that is transmitted from the at least one first computer.

15. The processing control method according to claim 14, wherein
a load estimating process of estimating a processing load of the analysis target data in the at least one first computer and
a bandwidth estimating process of estimating a communication bandwidth of communication between the at least one first computer and the at least one second computer are further carried out by the at least one processor, and
in the switching control process,
control of which computer analyzes the analysis target data, the at least one first computer or the at least one second computer is carried out by the at least one processor based on the processing load estimated and the communication bandwidth estimated.

16. The processing control method according to claim 14, wherein
the analysis target data has a plurality of chronologically successive frames,
the at least one first computer and the at least one second computer process the analysis target data in unit frame sets, each of which is a processing unit and is constituted by a predetermined number of frames, and
in the buffer control process,
a buffer frame quantity which is equal to or smaller than the predetermined number is determined by the at least one processor; and
upon switching of processing of the analysis target data to one of the at least one first computer and the at least one second computer that is not processing the analysis target data, the one to which the switching is made is caused by the at least one processor to analyze the analysis target data with use of frames which are buffered and the number of which is the buffer frame quantity.

17. The processing control method according to claim 16, wherein
in the buffer control process, the buffer frame quantity is determined by the at least one processor based on the communication bandwidth estimated.

18. The processing control method according to claim 16, wherein
a communication bandwidth is allocated for transmitting the analysis target data, and
in the buffer control process, the buffer frame quantity is determined by the at least one processor based on the communication bandwidth allocated.

19. The processing control method according to claim 16, wherein
a processing result acquiring process of acquiring reliability of processing of the analysis target data is further carried out by the at least one processor, and
in the buffer control process, the buffer frame quantity is determined by the at least one processor based on the reliability.

20. The processing control method according to claim 16, wherein
an importance judging process of judging importance of each portion of the analysis target data is further carried out by the at least one processor, and
in the buffer control process, the buffer frame quantity is determined by the at least one processor based on the importance.
